(19) United States
(12) Patent Application Publication
(10) Pub. No.: US 2008/0252809 A1
(43) Pub. Date: Oct. 16, 2008

(54) Backlight module and liquid crystal display device using same

(75) Inventors: Xiao-Hong Jing, Shenzhen (CN); Chien-Chung Fang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignees: INNOCOM TECHNOLOGY (SHENZHEN) CO., LTD.; INNOLUX DISPLAY CORP.

(21) Appl. No.: 12/082,556

(22) Filed: Apr. 11, 2008

(30) Foreign Application Priority Data
Apr. 11, 2007 (CN) 200720119414.1

(51) Int. Cl. G02F 1/13357; F21V 17/00

(52) U.S. Cl. 349/58; 362/219

(57) ABSTRACT

An exemplary backlight module (200) includes a frame (210) including a light-emitting opening (212), a plurality of light tubes (230) accommodated in the frame and disposed corresponding to the light-emitting opening, and a cover (215). Each light tube includes a bent portion (234), and the cover is disposed to cover the bent portions of the light tubes. A liquid crystal display device (2) using the backlight module is also provided.

### FIELD OF THE INVENTION

The present invention relates to backlight modules, and more particularly to a backlight module having improved light utilization with the aid of a lamp end cover. The present invention also relates to a liquid crystal display (LCD) device using the backlight module.

### GENERAL BACKGROUND

A typical LCD device has the advantages of portability, low power consumption, and low radiation, and has been widely used in various portable information products such as notebooks, personal digital assistants (PDAs), video cameras, and the like. The LCD device includes a liquid crystal panel and a backlight module. The liquid crystal panel cannot itself emit light. Therefore the backlight module is provided to illuminate the liquid crystal panel and enable the LCD device to operate.

Backlight modules are typically divided into two major categories: edge type and direct type. The direct type backlight module can provide higher intensity of light, and is thus more suited for large size liquid crystal panels than the edge type backlight module.

Referring to FIG. 9, a schematic, top plan view of a backlight module 100 of a conventional LCD device is shown. The backlight module 100 is a direct type backlight module, and includes a frame 110, a reflective element 120, and a plurality of light tubes 130. The light tubes 130 are typically fluorescent lamps.

Referring also to FIG. 10 and FIG. 11, the frame 110 includes a bottom plate 111 and a light-emitting opening 112. The reflective element 120 is disposed on the bottom plate 111, and the light tubes 130 are disposed above the reflective element 120. Each light tube 130 includes a bent portion 134 and two straight portions 132. The bent portions 134 are covered by the frame 110, and the straight portions 132 are disposed corresponding to the light-emitting opening 112. Light beams emitted from the straight portions 132 pass through the light-emitting opening 112 and illuminate a liquid crystal panel of the LCD device.

Light beams emitted from the bent portions 134 are too concentrated, and are liable to adversely affect the uniformity of brightness of the backlight module 100. Thus, the frame 110 is configured so that it covers the bent portions 134. However, some of the light beams emitted from the straight portions 132 transmit to the area corresponding to the bent portions 134, and these light beams are also covered by the frame 110. Thus, the some of the light beams emitted from the straight portions 132 are wasted, and the ratio of light utilization of the backlight module 100 is reduced.

What is needed, therefore, is a backlight module which can overcome the above-described deficiencies. What is also needed is an LCD device employing such a backlight module.

### SUMMARY

In one aspect, a backlight module includes a frame including a light-emitting opening, a plurality of light tubes accommodated in the frame and disposed corresponding to the light-emitting opening, and at least one cover. Each light tube includes at least one bent portion, and the at least one cover is disposed to cover the bent portions of the light tubes.

In another aspect, a backlight module includes a frame including a light-emitting opening divided into a first area and a second area, a plurality of light tubes accommodated in the frame, and at least one cover. Each light tube includes at least one bent portion and at least two straight portions. The first area corresponds to the bent portions, and the second area corresponds to the straight portions. The at least one cover is disposed at the first area, and the at least one cover provides at least one light transmission path at the first area. The at least one cover is configured to provide the following characteristics of light transmission: light beams emitted from the bent portions of the light tubes have a selected one of the following characteristics of light transmission: all the light beams emitted from the bent portions are blocked by the at least one cover and do not transmit through the at least one light transmission path; and some of the light beams emitted from the bent portions transmit through the at least one light transmission path to an outside of the light-emitting opening; and some of light beams emitted from the straight portions transmit through the at least one light transmission path to the outside of the light-emitting opening.

In still another aspect, a liquid crystal display device includes a liquid crystal panel and a backlight module disposed opposite to the liquid crystal panel. The backlight module includes a frame including a light-emitting opening divided into a first area and a second area, a plurality of light tubes accommodated in the frame, and at least one cover. Each light tube includes at least one bent portion and at least two straight portions. The first area corresponds to the bent portions, and the second area corresponds to the straight portions. The at least one cover is disposed at the first area, and the at least one cover provides at least one light transmission path at the first area. The at least one cover is configured to provide the following characteristics of light transmission: light beams emitted from the bent portions of the light tubes have a selected one of the following characteristics of light transmission: all the light beams emitted from the bent portions are blocked by the at least one cover and do not transmit through the at least one light transmission path; and some of the light beams emitted from the bent portions transmit through the at least one light transmission path to an outside of the light-emitting opening; and some of light beams emitted from the straight portions transmit through the at least one light transmission path to the outside of the light-emitting opening.

Other novel features and advantages will become more apparent from the following detailed description when taken in conjunction with the accompanying drawings. In the drawings, all the views are schematic.

### BRIEF DESCRIPTION OF THE DRAWINGS

FIG. 1 is an exploded, side view of an LCD device according to a first embodiment of the present invention, the LCD device including a backlight module.

FIG. 2 is a top plan view of the backlight module of FIG. 1, showing portions of light tubes thereof in phantom.

FIG. 3 is a cross-sectional view taken along line III-Ill of FIG. 2.

FIG. 4 is a top plan view of a backlight module of an LCD device according to a second embodiment of the present invention, showing portions of light tubes thereof in phantom.

FIG. 5 is a top plan view of a backlight module of an LCD device according to a third embodiment of the present invention, showing portions of light tubes thereof in phantom.

FIG. 6 is a top plan view of a backlight module of an LCD device according to a fourth embodiment of the present invention, showing portions of light tubes thereof in phantom.

FIG. 7 is a top plan view of a backlight module of an LCD device according to a fifth embodiment of the present invention, showing portions of light tubes thereof in phantom.

FIG. 8 is a top plan view of a backlight module of an LCD device according to a sixth embodiment of the present invention, showing portions of light tubes thereof in phantom.

FIG. 9 is a top plan view of a backlight module of a conventional LCD device, showing portions of light tubes thereof in phantom.

FIG. 10 is a cross-sectional view taken along line X-X of FIG. 9.

FIG. 11 is a cross-sectional view taken along line XI-XI of FIG. 9.

### DETAILED DESCRIPTION OF PREFERRED EMBODIMENTS

Reference will now be made to the drawings to describe various embodiments of the present invention in detail.

Referring to FIG. 1, an exploded, side view of an LCD device according to a first embodiment of the present invention is shown. The LCD device 2 includes a liquid crystal panel 100 and a backlight module 200. The backlight module 200 is disposed opposite to the liquid crystal panel 100, and is used for providing light beams to the liquid crystal panel 100.

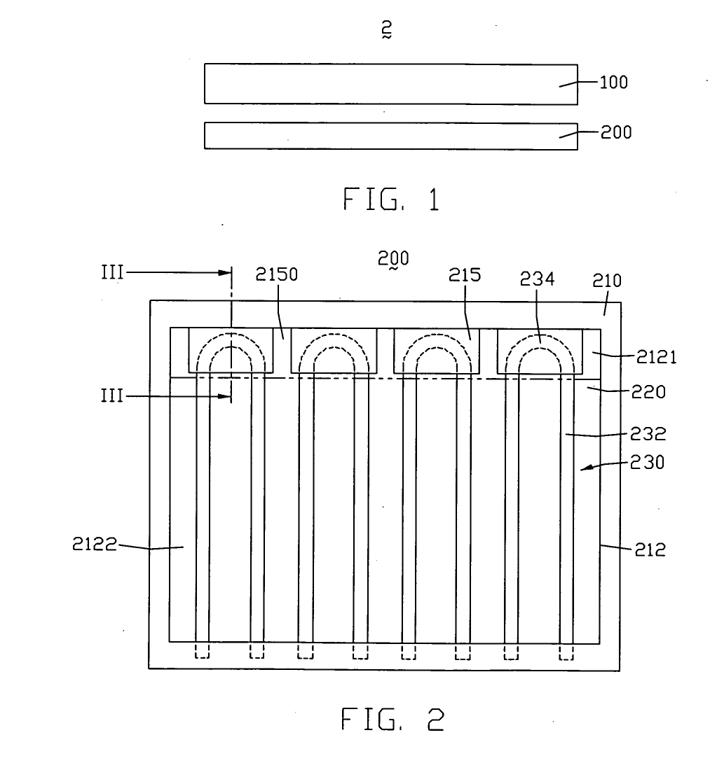

Referring to FIG. 2, a schematic, top plan view of the backlight module 200 is shown. The backlight module 200 is a direct type backlight module, and includes a frame 210, a reflective element 220, a plurality of light tubes 230, and various optical elements (not shown) such as a diffusing element, a brightness enhancement film, and the like. The frame 210 may be made of plastic, and includes a light-emitting opening 212. Light beams emitted from the light tubes 230 transmit through the light-emitting opening 212 and the optical elements, and then illuminate the liquid crystal panel 100.

The light tubes 230 may be cold cathode fluorescent lamps, and the frame 210 may be made of plastic. Each light tube 230 is a U-shaped light tube, and includes a bent portion 234 and two straight portions 232. The light-emitting opening 212 is defined to include a first area 2121 and a second area 2122. The first area 2121 corresponds to the bent portions 234, and the second area 2122 corresponds to the straight portions 232. A plurality of lamp end covers 215 is provided at the first area 2121, corresponding to the bent portions 234 of the light tubes 230 respectively. The size of each lamp end cover 215 is larger than that of each bent portion 234. Each two adjacent lamp end covers 215 are separated by a gap 2150. The lamp end covers 215 may be rectangular sheets, semicircular sheets, trapezoidal sheets, or other sheets having another suitable shape.

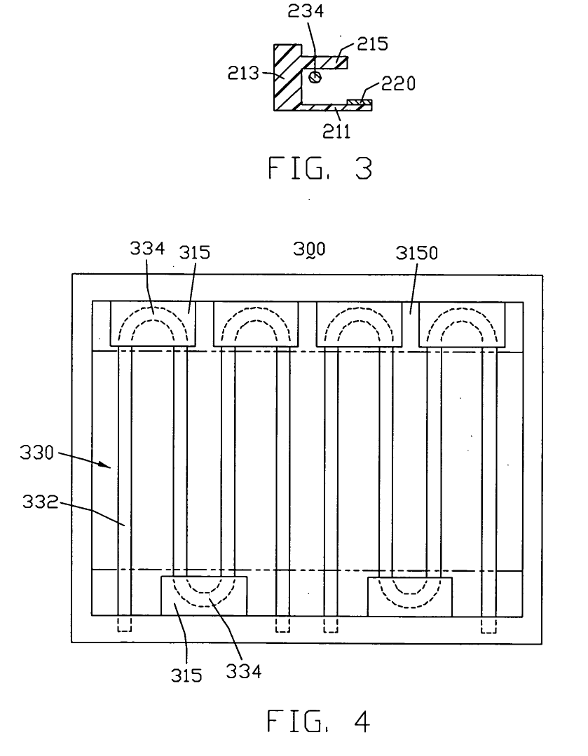

Referring also to FIG. 3, a side cross-sectional view of part of the backlight module 200 is shown. The frame 210 includes a bottom plate 211 and four side walls 213. The optical elements and the frame 210 form a closed space to accommodate the light tubes 230 and the reflective element 220. The reflective element 220 is disposed on the bottom plate 211, and the light tubes 230 are disposed above the reflective element 220. The reflective element 220 can for example be a sheet of reflective material or a coating of reflective material. Each lamp end cover 215 extends perpendicularly from a side wall 213 toward an inside of the frame 210. The lamp end covers 215 are arranged horizontally, and are spaced a same distance above the bottom plate 211. Alternatively, the lamp end covers 215 can be arranged alternately, wherein they are spaced different distances above the bottom plate 211. In one embodiment, the lamp end covers 215 and the frame 210 are portions of the same single body of material. For example, the material is plastic, and the lamp end covers 215 and the frame 210 are integrally formed together in a single molding process.

In the second area 2122 of the light-emitting opening 212, most of light beams emitted from the straight portions 232 transmit directly to the optical elements, or transmit toward the reflective element 220 and then are reflected up to the optical elements. In the first area 2121 of the light-emitting opening 212, most of light beams emitted from the bent portions 234 are blocked by the lamp end covers 215. Some of the light beams emitted from the bent portions 234 transmit to the optical elements via the gaps 2150 between the lamp end covers 215. In addition, some of the light beams emitted from the straight portions 232 transmit to the first area 2121 and then to the optical elements via the gaps 2150 between the lamp end covers 215.

Because of the gaps 2150 between the lamp end covers 215, in the first area 2121 of the light-emitting opening 212, some of the light beams emitted from the bent portions 234 and the straight portions 232 can transmit to the optical elements. Therefore a high proportion of light beams can be utilized by the backlight module 200, without necessarily materially affecting the uniformity of brightness provided by the backlight module 200. Thus the backlight module 200 is able to provide highly uniform bright illumination, by way of improved light utilization. In addition, the gaps 2150 mean that the amount of material needed to make the frame 210 can be less than that needed for a conventional frame. Furthermore, the sizes of the lamp end covers 215 can be designed according to the sizes of the bent portions 234.

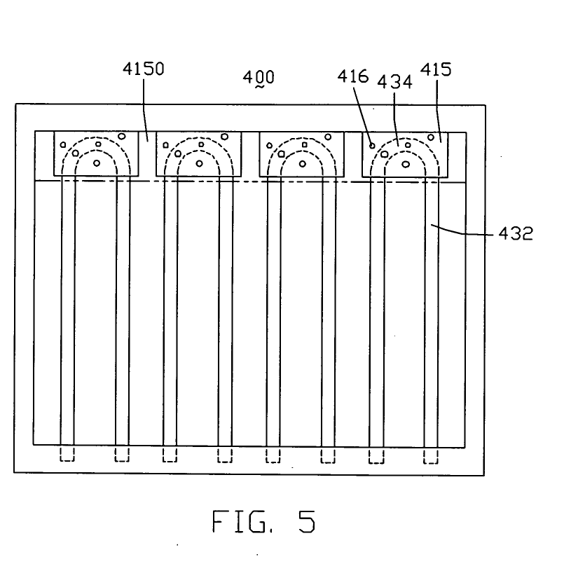

Referring to FIG. 4, a schematic, top plan view of a backlight module 300 of an LCD device according to a second embodiment of the present invention is shown. The backlight module 300 is similar to the backlight module 200. However, each of light tubes 330 of the backlight module 300 is a generally W-shaped light tube, and includes three bent portions 334 and four straight portions 332. Each of bent portions 334 corresponds to each of lamp end covers 315. Most of light beams emitted from the bent portions 334 transmit directly to the lamp end covers 315, and are blocked by the lamp end covers 315. Some of the light beams emitted from the bent portions 334 and from the straight portions 332 transmit to optical elements (not shown) via gaps 3150 between the lamp end covers 315.

Referring to FIG. 5, a schematic, top plan view of a backlight module 400 of an LCD device according to a third embodiment of the present invention is shown. The backlight module 400 is similar to the backlight module 200. However, each of lamp end covers 415 further includes a plurality of through holes 416. The through holes 416 may be circular, semicircular, square, rectangular, another shape, or a mixture of at least two different kinds of such shapes. Therefore, some light beams emitted from bent portions 434 and straight portions 432 transmit to optical elements (not shown) not only via gaps 4150 between the lamp end covers 415, but also via the through holes 416. The through holes 416 can further improve the light utilization of the backlight module 400.

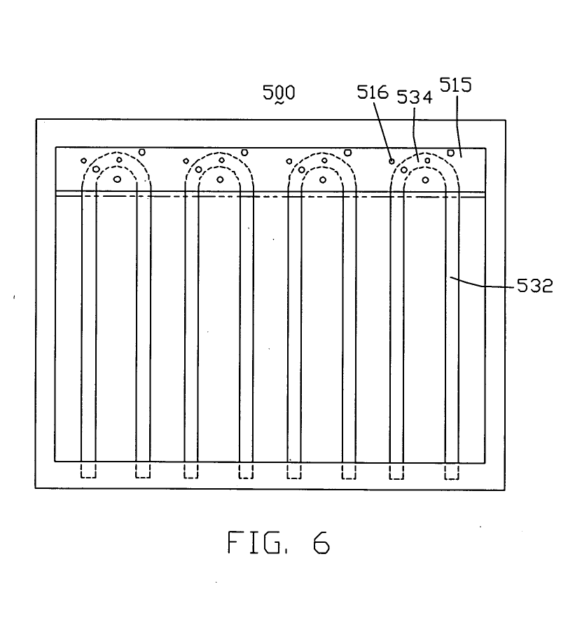

Referring to FIG. 6, a schematic, top plan view of a backlight module 500 of an LCD device according to a fourth embodiment of the present invention is shown. The backlight module 500 is similar to the backlight module 200. However, the backlight module 500 includes a single lamp end cover 515. The lamp end cover 515 is a rectangular sheet, and is long enough to cover all of bent portions 534. The lamp end cover 515 includes a plurality of through holes 516. The through holes 516 may be circular, semicircular, square, rectangular, another shape, or a mixture of at least two different kinds of such shapes. Therefore, some light beams emitted from the bent portions 534 and from straight portions 532 transmit to optical elements (not shown) via the through holes 516.

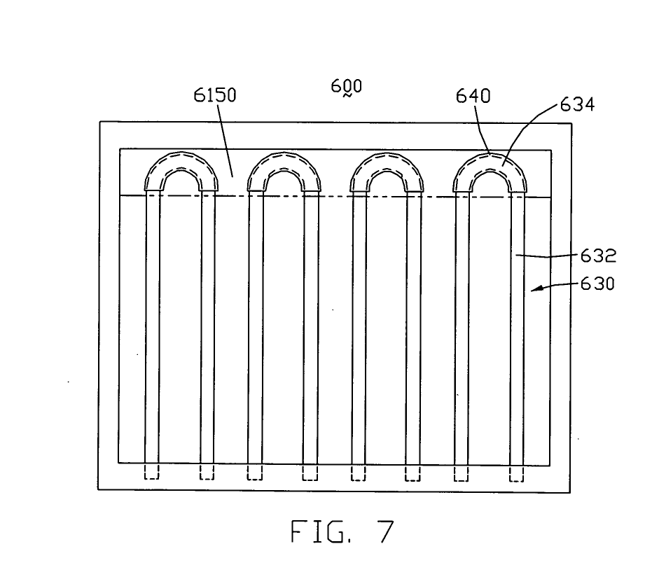

Referring to FIG. 7, a schematic, top plan view of a backlight module 600 of an LCD device according to a fifth embodiment of the present invention is shown. The backlight module 600 is similar to the backlight module 200. However, a plurality of lamp end covers 640 of the backlight module 600 is fitted on a plurality of bent portions 634 of light tubes 630, respectively. Each lamp end cover 640 may for example be a casing pipe, a casing half-pipe, or a film. The lamp end cover 640 is typically made of heat-resistant, elastic material, such as polyethylene, polyvinyl chloride, and the like. The lamp end covers 640 have the characteristic of opacity, or are semitransparent. Most of light beams emitted from the bent portions 634 are blocked by the lamp end covers 640.

Because the lamp end covers 640 are light and thin, each lamp end cover 640 can closely fit around the corresponding bent portion 634. Thereby, gaps 6150 are provided between each two adjacent lamp end covers 640. Accordingly, some light beams emitted from straight portions 632 transmit to optical elements (not shown) via the gaps 6150. Furthermore, the lamp end covers 640 are relatively small and light, and can be made thin. Thus the backlight module 600 can correspondingly be light, thin, and compact.

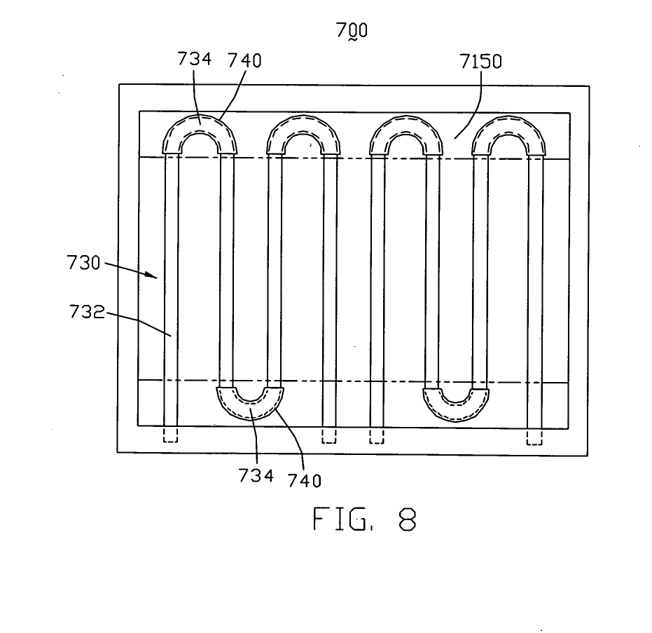

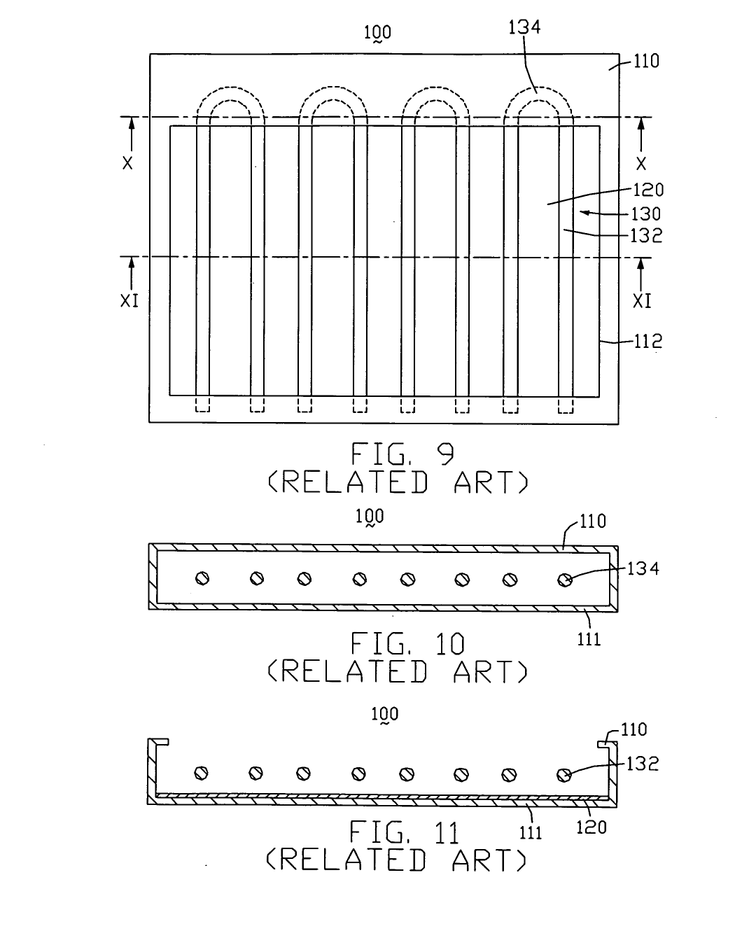

Referring to FIG. 8, a schematic, top plan view of a backlight module 700 of an LCD device according to a sixth embodiment of the present invention is shown. The backlight module 700 is similar to the backlight module 600. However, each of light tubes 730 of the backlight module 700 is a generally W-shaped light tube, and includes three bent portions 734 and four straight portions 732. Each bent portion 734 has a lamp end cover 740 fitted thereon. Most of light beams emitted from the bent portions 734 are blocked by the lamp end covers 740. Some light beams emitted from the straight portions 732 transmit to optical elements (not shown) via gaps 7150 between each two adjacent lamp end covers 740.

It is to be understood, however, that even though numerous characteristics and advantages of preferred and exemplary embodiments have been set out in the foregoing description, together with details of the structures and functions of the embodiments, the disclosure is illustrative only; and that changes may be made in detail, especially in matters of shape, size, and arrangement of parts within the principles of the present invention to the full extent indicated by the broad general meaning of the terms in which the appended claims are expressed.

What is claimed is:

1. A backlight module, comprising:
a frame comprising a light-emitting opening;
a plurality of light tubes accommodated in the frame and disposed corresponding to the light-emitting opening, each light tube comprising at least one bent portion; and
at least one cover;
wherein the at least one cover is disposed to cover the bent portions of the light tubes.

2. The backlight module as claimed in claim 1, wherein the frame further comprises a bottom plate and a plurality of side walls, and the at least one cover is extending perpendicularly from at least one of the side walls towards an inside of the frame.

3. The backlight module as claimed in claim 2, wherein the at least one cover is configured as a plurality of rectangular sheets, and the rectangular sheets define a gap with each other.

4. The backlight module as claimed in claim 3, wherein the size of each cover is larger than that of each bent portion.

5. The backlight module as claimed in claim 4, wherein each cover comprises a plurality of through holes.

6. The backlight module as claimed in claim 4, wherein the covers are arranged horizontally, and are spaced a same distance above the bottom plate.

7. The backlight module as claimed in claim 4, wherein the covers are arranged alternately, and are spaced different distances above the bottom plate.

8. The backlight module as claimed in claim 2, wherein the at least one cover is a single cover, the cover is a rectangular sheet, and is long enough to cover all of the bent portions.

9. The backlight module as claimed in claim 8, wherein the cover comprises a plurality of through holes.

10. The backlight module as claimed in claim 1, wherein the at least one cover is configured as a plurality of casing pipes, the casing pipes are configured for being fitted on the bent portions, respectively.

11. The backlight module as claimed in claim 10, wherein the at least one cover is made of heat-resistant, elastic materials.

12. The backlight module as claimed in claim 11, wherein the at least one cover is configured for having the characteristics of opacity.

13. The backlight module as claimed in claim 11, wherein the at least one cover is configured for being semitransparent.

14. A backlight module, comprising:
a frame comprising a light-emitting opening divided into a first area and a second area;
a plurality of light tubes accommodated in the frame, each light tube comprising at least one bent portion and at least two straight portions; and
at least one cover;
wherein the first area corresponds to the bent portions, the second area corresponds to the straight portions, the at least one cover is disposed at the first area, and the at least one cover provides at least one light transmission path at the first area; and
the at least one cover is configured to provide the following characteristics of light transmission:
light beams emitted from the bent portions of the light tubes have a selected one of the following characteristics of light transmission:
all the light beams emitted from the bent portions are blocked by the at least one cover and do not transmit through the at least one light transmission path; and
some of the light beams emitted from the bent portions transmit through the at least one light transmission path to an outside of the light-emitting opening; and
some of light beams emitted from the straight portions transmit through the at least one light transmission path to the outside of the light-emitting opening.

15. The backlight module as claimed in claim 14, wherein the frame further comprises a bottom plate and a plurality of side walls, the at least one cover is extending perpendicularly from at least one of the side walls towards an inside of the frame, and the at least one cover is rectangular sheet.

16. The backlight module as claimed in claim 14, wherein the at least one cover is configured as a plurality of casing pipes, the casing pipes are configured for being fitted on the bent portions, respectively.

17. A liquid crystal display device, comprising:
a liquid crystal panel; and
a backlight module disposed adjacent to the liquid crystal panel, the backlight module comprising:
a frame comprising a light-emitting opening divided into a first area and a second area;
a plurality of light tubes accommodated in the frame, each light tube comprising at least one bent portion and at least two straight portions; and
at least one cover;
wherein the first area corresponds to the bent portions, the second area corresponds to the straight portions, the at least one cover is disposed at the first area, and the at least one cover provides at least one light transmission path at the first area; and
the at least one cover is configured to provide the following characteristics of light transmission:
light beams emitted from the bent portions of the light tubes have a selected one of the following characteristics of light transmission:
all the light beams emitted from the bent portions are blocked by the at least one cover and do not transmit through the at least one light transmission path; and
some of the light beams emitted from the bent portions transmit through the at least one light transmission path to an outside of the light-emitting opening; and
some of light beams emitted from the straight portions transmit through the at least one light transmission path to the outside of the light-emitting opening.

18. The liquid crystal display device as claimed in claim 17, wherein the frame further comprises a bottom plate and a plurality of side walls, the at least one cover is extending perpendicularly from at least one of the side walls towards an inside of the frame, and the at least one cover is rectangular sheet.

19. The liquid crystal display device as claimed in claim 17, wherein the at least one cover is configured as a plurality of casing pipes, the casing pipes are configured for being fitted on the bent portions, respectively.
